(19) United States
(12) Patent Application Publication
(10) Pub. No.: US 2007/0076352 A1
(43) Pub. Date: Apr. 5, 2007

(54) Ballast insulator

(76) Inventor: Larry Hart, Redondo Beach, CA (US)

Correspondence Address: EDWIN TARVER, 16830 Ventura Blvd., SUITE 360, Encino, CA, 91436, US

(21) Appl. No.: 11/243,331

(22) Filed: Oct. 4, 2005

(51) Int. Cl. H02B 1/00

(52) U.S. Cl. 361/600

(57) ABSTRACT

The present invention discloses a sheet-like insulator structure for dampening vibrations and lowering the sound level of a ballast for a fluorescent lamp. The ballast insulator is made of neoprene and is approximately 0.25 inches thick and fixed between the ballast and the mounting location. The ballast insulator comprises a shape that conforms to the shape of the bottom of the ballast.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to a ballast accessory, and more particularly to a sheet-like piece or shield that dampens vibrations and sound when affixed between the ballast and the mounting location.

Fluorescent lights are commonly known in the lighting industry and are used in a broad variety of applications. These devices require electric ballasts in order to operate. Ballasts are typically contained in a ballast fixture and maintained above the fluorescent light source. A ballast, fixture or case for a fluorescent lamp normally comprises a ballast enclosure and a cover in a rectangular shape that is anchored at either end to the mounting location with screws.

A persistent problem with fluorescent light fixtures is the buzz or humming sound generated by the ballast when a fluorescent light is in operation. Since ballasts typically generate noise during operation, this sound must be muffled or muted in order to ensure quiet when fluorescent lights are on. It is desirable to bring the sound level of ballasts fastened to lighting fixtures to below 25 decibels (dB). However, it is difficult to reduce the sound generated by a ballast.

Several improvements and developments have been made to dampen vibrations and sound in ballasts. These include devices utilizing sound insulation and vibration damping materials; coating the ballast with resin, making structural and design changes, etc. For example, U.S. Pat. No. 5,508,882 to Lee discloses an invention wherein a potting compound is installed into a ballast case. The compound protects the ballast and its associated parts, and dampens vibrations and sound. The ballast case has inwardly embossed sections to accommodate the potting compound between the ballast and the case. However, since the potting compound does not completely surround the ballast, changing worn out parts of the ballast are impractical. Moreover, the potting compound degrades over time and cannot be used with conventional ballasts.

U.S. Pat. No. 4,514,713 to Van Dam, and U.S. Pat. No. 4,082,141 to Perretta also disclose inventions designed to reduce sound vibrations caused by a ballast. Van Dam discloses a method of coating a ballast with an insulating layer of synthetic resin. First, the terminals of the ballast are covered to protect them from the resin. Then the ballast is coated with resin by dipping or spraying to seal it. However, the resin is a poor sound insulator, and cannot be removed. Furthermore, the coating process adds an unnecessary level of complexity since a special process is required to coat the ballast.

Perretta discloses a pair of L-shaped channels intended to raise and isolate the ballast from its mounting plate. However, this invention is designed principally for heat diffusion. The only sound dampening element of the invention consists of elastic washers intended to dampen vibrations. For this reason, persons in a room can still hear the humming sound emitted from the ballast when a fluorescent lamp is switched on.

Therefore, there is a need for an improved ballast insulator that succeds in dampening vibrations and sound, not only from the internal sound level of a ballast but also from the connection of the ballast to a lighting fixture. This objective can be achieved by installing the sheet-like ballast insulator of the present invention between the ballast and the mounting location.

### SUMMARY

The present invention relates in general to a ballast accessory, and more particularly to a sheet-like piece or shield that helps in dampening vibrations and sound when affixed between a ballast and the location where it is mounted. The sheet is made of neoprene and is of the same dimensions as the back surface of the ballast. The sheet also includes suitable provisions for easy installation including slots for mounting screws at either longitudinal end of the ballast insulator.

These and other features, aspects, and advantages of the present invention will become better understood with reference to the following description and appended claims.

### BRIEF DESCRIPTION OF THE FIGURES

FIG. 1 is a plan view of a sheet-like piece or shield in accordance with the present invention.

FIG. 2 is a perspective view of conventional ballast with the cover-like sheet in accordance with the present invention.

FIG. 3 is a perspective view of conventional ballast with the cover-like sheet installed on a surface in accordance with the present invention.

FIG. 4 is a sectional view of conventional ballast with the cover-like sheet installed on a surface in accordance with the present invention.

### FIGURES—REFERENCE NUMERALS

10 ... Ballast Insulator
11 ... Hole
12 ... Slot
13 ... Conventional Ballast
14 ... Ballast Enclosure
15 ... Ballast Cover
16 ... Mounting Surface

### DESCRIPTION

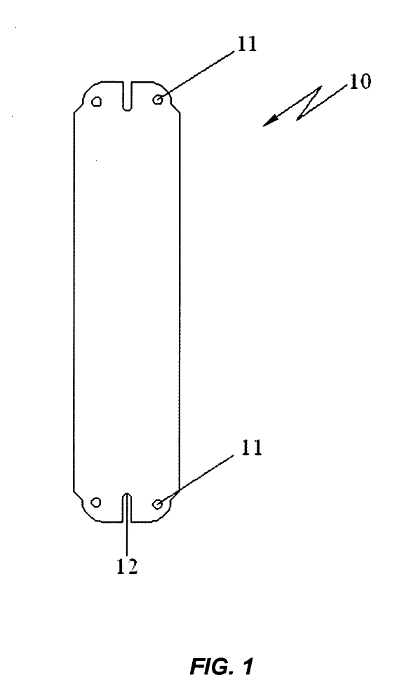

Referring to FIG. 1, a sheet-like piece or ballast insulator of the present invention is illustrated and generally indicated as 10. The insulator 10 is made of neoprene and approximately 0.25 inches thick. The sheet 10 includes a plurality of holes 11 and slots 12. The size of the sheet 10 is of the same size as that of the back surface of a conventional ballast for a fluorescent lamp, and therefore its shape conforms to the bottom dimension of the ballast. Many sizes and shapes of the sheet 10 are possible to cover the back surfaces of different ballasts.

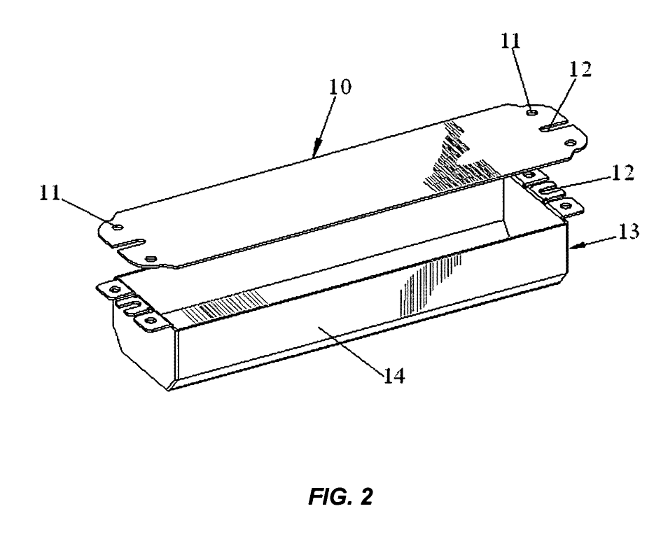

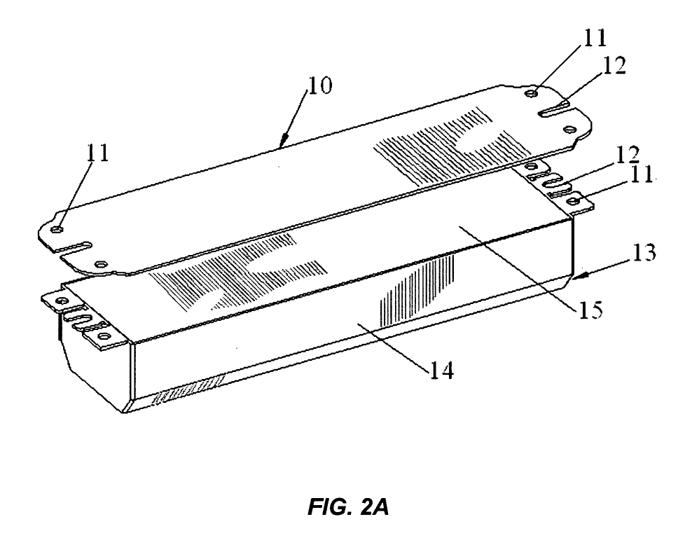

Referring to FIG. 2, the ballast 13 typically comprises a ballast enclosure 14 and a cover 15. The cover 15 covers the back surface of the ballast enclosure 14. The ends of the ballast 13 consist of a plurality of holes 11 and sometimes slots 12. The sheet 10 of the present invention comprises same sized holes 11 to match those present in the ballast 13.

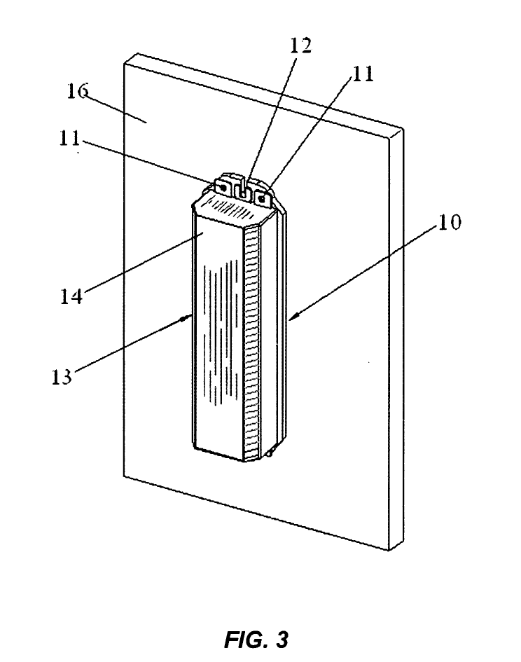

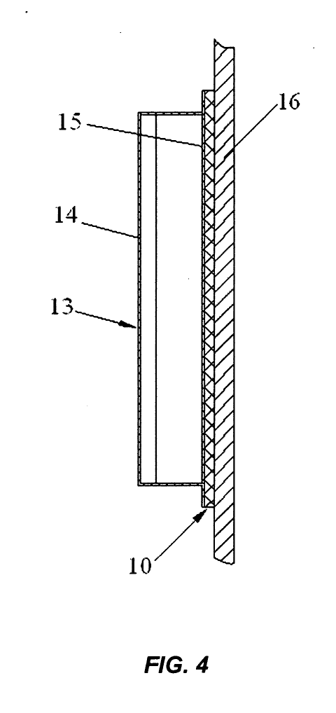

Referring to FIGS. 3 and 4, the ballast insulator 10 is installed between the ballast 13 and the surface where it is mounted 16. In general, mounting screws or nuts (not shown) are used for installing the ballast 13. The sheet 10 is placed on the back surface of the ballast 13 such that the holes of the sheet 10 and the ballast 13 align with each other. The screws or nuts are then inserted in to the holes 11 and fastened to the mounting surface 16 to install the ballast 13. Elastomeric washers (not shown) may also be provided for installation on mounting screws or nuts, which further help in preventing the sound to travel from the screws or nuts to the lighting fixture. The elastomeric washers may be of any suitable well-known material such as synthetic plastics, rubber or the like.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While specific apparatus has been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

What is claimed is:

1. A ballast insulator for a fluorescent lamp comprising a cover-like sheet of neoprene that covers the entire back surface of a ballast, and contains a plurality of holes or recesses that match the holes or recesses of the ballast for fastening the ballast insulator between the ballast and the ballast mounting location.

2. The ballast insulator of claim one, including elastomeric washers between the ballast and the ballast insulator.

3. The ballast insulator of claim one, wherein the plurality of holes are of the same size as the mounting holes of the ballast.

4. The ballast insulator of claim one, wherein the ballast insulator is made of neoprene and is approximately 0.25 inches thick.

5. The ballast insulator of claim one, wherein the cover-like sheet structure can be of any size or shape that conforms to the surface of a ballast and the mounting surface.

6. The ballast insulator of claim 1, wherein the elastomeric washer is made of synthetic plastic or rubber.
